(19) United States
(12) Patent Application Publication
(10) Pub. No.: US 2018/0251167 A1
(43) Pub. Date: Sep. 6, 2018

(54) Dynamic ballast for a work machine

(71) Applicant: Deere & Company, Moline, IL (US)

(72) Inventors: Scott S. Hendron, Dubuque, IA (US); Wylie C. Pfaff, Dubuque, IA (US); Robert C. Moore, Dubuque, IA (US); Martti Johannes Lampela, Newbury Park, CA (US); John William Krieger, Newbury Park, CA (US); Peter Fraser Falt, Newbury Park, CA (US); Michael McLaughlin, Newbury Park, CA (US)

(21) Appl. No.: 15/448,263

(22) Filed: Mar. 2, 2017

(51) Int. Cl. B62D 49/08; B62D 37/06

(52) U.S. Cl. CPC B62D 49/085; B62D 37/06

(57) ABSTRACT

A ballast device for a work vehicle. The ballast device comprising a rail coupled to the work vehicle. A carrier is slidingly coupled to the rail. The carrier comprises a pin having an axis of rotation. An actuator is coupled to the carrier and configured to move the carrier along the rail. A counterweight is rotatably coupled to the pin. A rotation device is coupled to the counterweight and configured for rotating the counterweight about the axis of rotation. A sensor is coupled to the work vehicle and configured for determining a center of gravity of the work vehicle and for generating a signal indicative of the center of gravity. A controller is configured for receiving the signal and configured for controlling the actuator and the rotation device to position the counterweight at an optimized location.

### FIELD OF THE DISCLOSURE

The present disclosure generally relates to work vehicles, and more particularly to a device and method for a ballast for a work vehicle.

### BACKGROUND OF THE DISCLOSURE

In order to stabilize a work vehicle, a fixed counterweight is commonly used in work vehicles.

### SUMMARY OF THE DISCLOSURE

In one embodiment, a ballast device for a work vehicle is disclosed. The ballast device comprises a rail coupled to the work vehicle. A carrier is slidingly coupled to the rail. The carrier comprises a pin having an axis of rotation. An actuator is coupled to the carrier and configured to move the carrier along the rail. A counterweight is rotatably coupled to the pin. A rotation device is coupled to the counterweight and configured for rotating the counterweight about the axis of rotation. A sensor is coupled to the work vehicle and configured for determining a center of gravity of the work vehicle and for generating a signal indicative of the center of gravity. A controller is configured for receiving the signal and configured for controlling the actuator and the rotation device to position the counterweight at an optimized location.

In another embodiment, a work vehicle is disclosed. The work vehicle comprises a frame having a recess. A ballast device is coupled to the frame. The ballast device comprises a rail coupled to the work vehicle. A carrier is slidingly coupled to the rail. The carrier comprises a pin having an axis of rotation. An actuator is coupled to the carrier and configured to move the carrier along the rail. A counterweight is rotatably coupled to the pin. A rotation device is coupled to the counterweight and configured for rotating the counterweight about the axis of rotation. A sensor is coupled to the work vehicle and configured for determining a center of gravity of the work vehicle and for generating a signal indicative of the center of gravity. A controller is configured for receiving the signal and configured for controlling the actuator and the rotation device to position the counterweight at an optimized location in the recess.

In yet another embodiment, a method for positioning a center of gravity of a work vehicle at an optimized location is disclosed. The method comprises providing a rail coupled to the work vehicle. The method further comprises sliding a carrier on the rail. The carrier comprising a pin having an axis of rotation. The method further comprises rotating a counterweight about the axis of rotation. The method further comprises determining the center of gravity of the work vehicle. The method further comprises positioning the counterweight at the optimized location.

Other features and aspects will become apparent by consideration of the detailed description and accompanying drawings.

### BRIEF DESCRIPTION OF THE DRAWINGS

FIG. 1 is a perspective view of a work vehicle according to one embodiment.

FIG. 2 is a partial side view of the work vehicle of FIG. 1.

FIG. 3 is a partial bottom view of the work vehicle of FIG. 1.

FIG. 4 is a partial top view of the work vehicle of FIG. 1 showing the ballast device.

FIG. 5 is a schematic of an illustrative method for positioning a center of gravity of a work vehicle at an optimized location.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

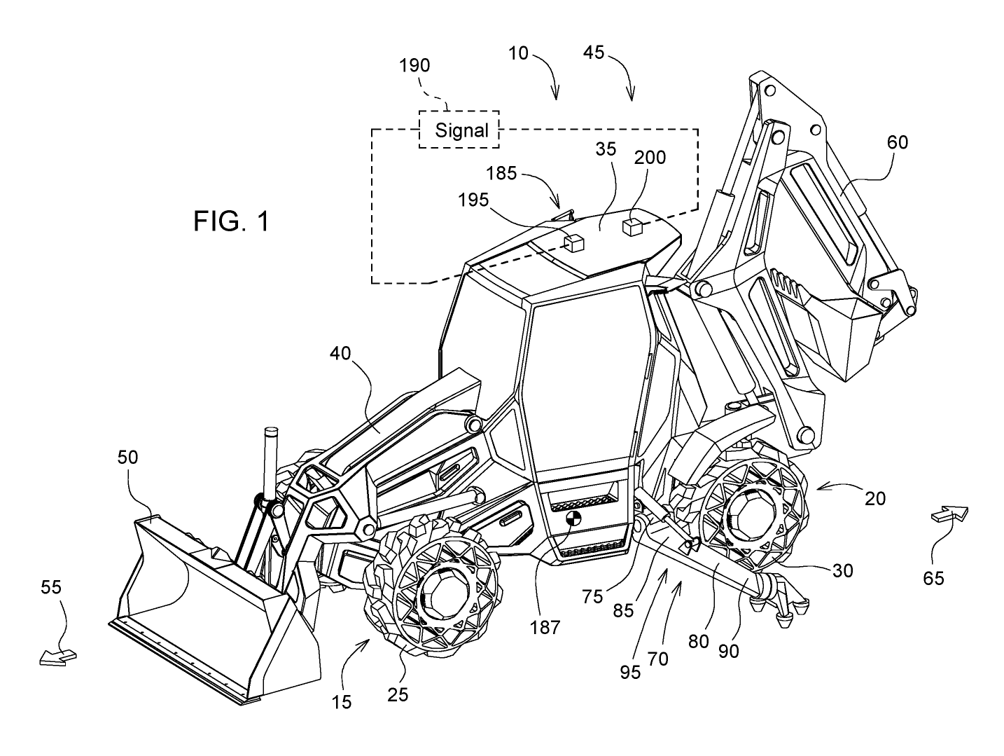

FIG. 1 illustrates a work vehicle 10 supported by a first ground-engaging device 15 and a second ground-engaging device 20. The first and second ground-engaging devices 15, 20 are configured to move the work vehicle 10 along a surface. The illustrated first ground-engaging device 15 is a first pair of wheels 25. The illustrated second ground-engaging device 20 is a second pair of wheels 30. The first and second pair of wheels 25, 30 may be the same size and may share an equal distribution of weight of the work vehicle 10. Alternatively, the first and second ground-engaging devices 15, 20 may be tracks (not shown).

The work vehicle 10 includes an operator's station 35. The work vehicle 10 may be powered by an engine 40 that is coupled to a transmission (not shown) for transferring power to the first ground-engaging device 15 and the second ground-engaging device 20. The engine 40 may be a diesel engine. Alternatively, the first and second ground-engaging devices 15, 20 may be turned by electric motors (not shown).

The illustrated work vehicle 10 is a backhoe 45. Other work vehicles 10 are contemplated by this disclosure (e.g., crawler, excavator). The work vehicle 10 may include a bucket 50 coupled to the work vehicle 10 forwardly 55 of the operator's station 35. The work vehicle 10 may include a boom 60 coupled to the work vehicle 10 rearwardly 65 of the operator's station 35.

The work vehicle 10 includes a stabilizer device 70. The stabilizer device 70 may be provided on each side of the work vehicle 10. A mount 75 is coupled to the work vehicle 10 between the first ground-engaging device 15 and the second ground-engaging device 20. A stabilizer bar 80 is coupled to the mount 75. The stabilizer bar 80 may comprise a first portion 85 and a second portion 90. The stabilizer bar 80 is configured to reach around the second ground-engaging device 20 and contact the surface in a ground-engaging position 95.

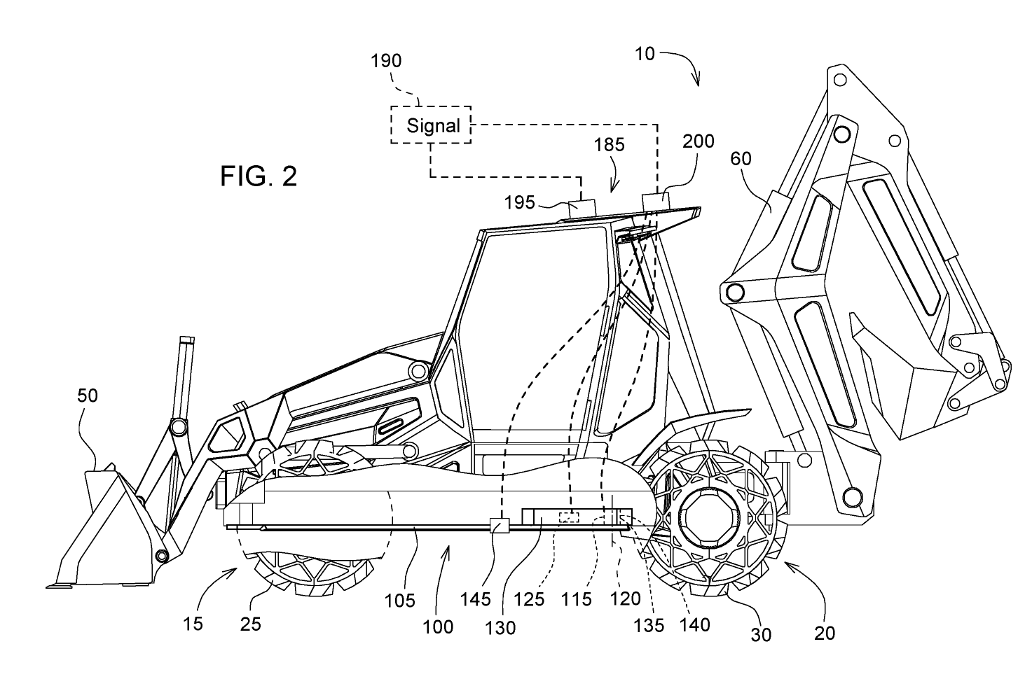

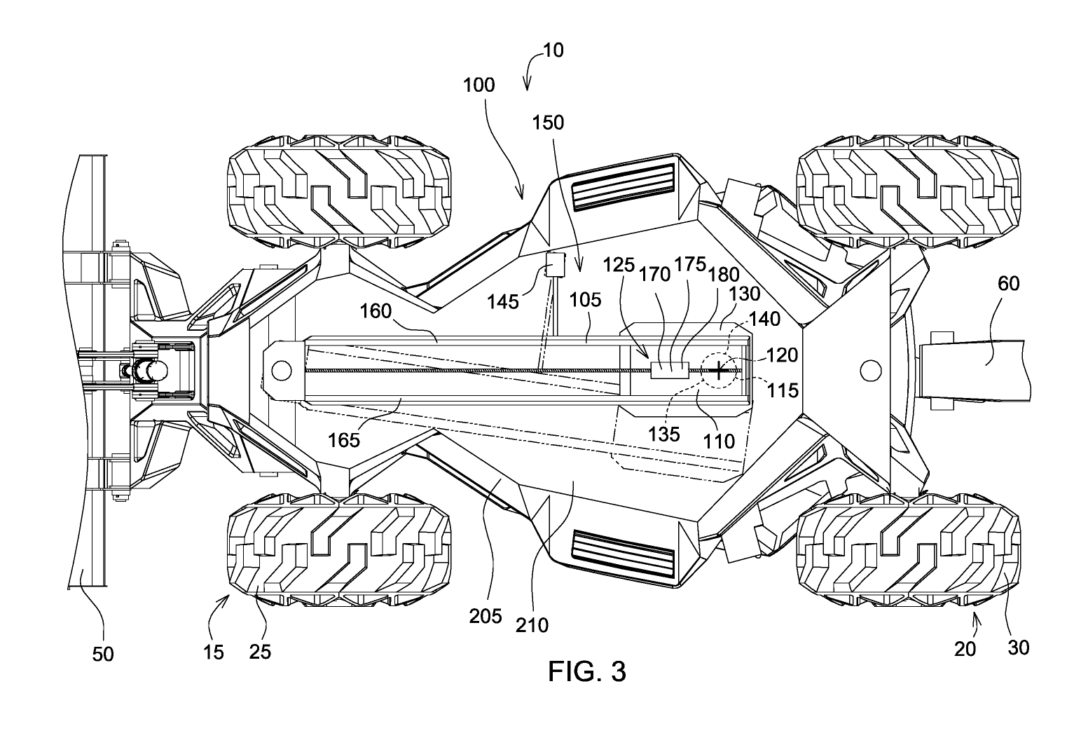

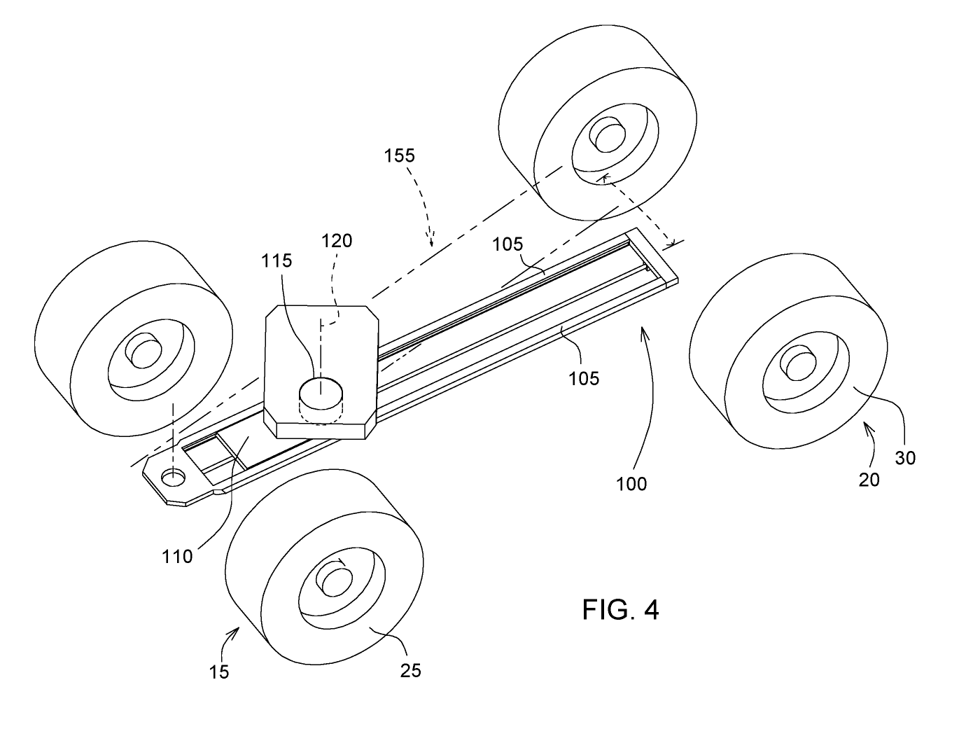

With reference to FIGS. 2 and 3, the work vehicle 10 includes a ballast device 100. The ballast device 100 comprises at least one rail 105 that is coupled to the work vehicle 10. The rail 105 may be a first rail 160 and a second rail 165 spaced from the first rail 160. A rail actuator 145 may be coupled to the rail 105 to move the rail 105 from a first position 150 to a second position 155 (FIG. 4).

A carrier 110 is slidingly coupled to the rail 105. The carrier comprises a pin 115 (FIG. 4) having an axis of rotation 120. It is contemplated that more than one carrier 110 may be slidingly coupled to the rail 105.

An actuator 125 is coupled to the carrier 110 and configured to move the carrier 110 along the rail 105. The actuator 125 may be a screw-type actuator 170 that moves along a threaded rod and may be hydraulic 175 or electric 180. Other types of actuators 125 are contemplated by this disclosure.

A counterweight 130 is rotatably coupled to the pin 115. The counterweight 130 may rotate 360 degrees about the pin 115. The illustrated counterweight 130 is substantially rectangular in shape and is rotatably coupled to the pin 115 at a position that is offset from a center of the counterweight 130. Other counterweight 130 shapes and coupling locations are contemplated by this disclosure.

A rotation device 135 is coupled to the counterweight 130 and configured for rotating the counterweight 130 about the axis of rotation 120. The rotation device 135 may be an integral motor 140 (e.g., electric, hydraulic) coupled to the inside of the pin 115 or other device. Alternatively, an outer portion of the rotation device 135 may be the pin 115. Other rotation devices 135 are contemplated by this disclosure (e.g., sprocket).

Referring to FIG. 1, a sensor 185 is coupled to the work vehicle 10. The sensor 185 is configured for determining a center of gravity 187 of the work vehicle 10 and for generating a signal 190 indicative of the center of gravity 187. The sensor 185 may be a gyroscope 195 or other type of sensor.

With reference to FIG. 2, a controller 200 is coupled to the work vehicle 10 and configured for receiving the signal 190 and configured for controlling the actuator 125 and the rotation device 135 to position the counterweight 130 at an optimized location. The optimized location may be where the work vehicle 10 is the most stable and may depend on the type of work being completed by the work vehicle 10 (e.g., boom 60 operating to one side, work vehicle 10 operating on a sloped surface) or the load the work vehicle 10 is carrying, moving, or otherwise working with. The controller 200 may also control the rail actuator 145 to position the counterweight 130 at the optimized location. The optimized location is determined using at least one of an algorithm, a look-up table, and operator input via an operator interface (not shown) in communication with the controller 200.

Referring to FIG. 3, the work vehicle 10 comprises a frame 205. The frame 205 has a recess 210. The ballast device 100 may be coupled to the frame 205. The controller 200 may position the counterweight 130 at the optimized location within the recess 210.

In operation, the counterweight 130 may be rotated around the axis of rotation 120 to shift the center of gravity 187 to the side, the counterweight 130 may be moved along the rail 105, the rail 105 may be moved from the first position 150 to the second position 155, or the rail 105 could be moved closer to the operator's station 35 or away from the operator's station 35 in a vertical direction (perpendicular to the direction forwardly 55 and/or rearwardly 65) using a vertical actuator (not shown) to position the counterweight 130 such that the center of gravity 187 is positioned at the optimized location to balance the work vehicle 10 to keep it from tipping or moving. Thus the ballast device 100 is dynamic.

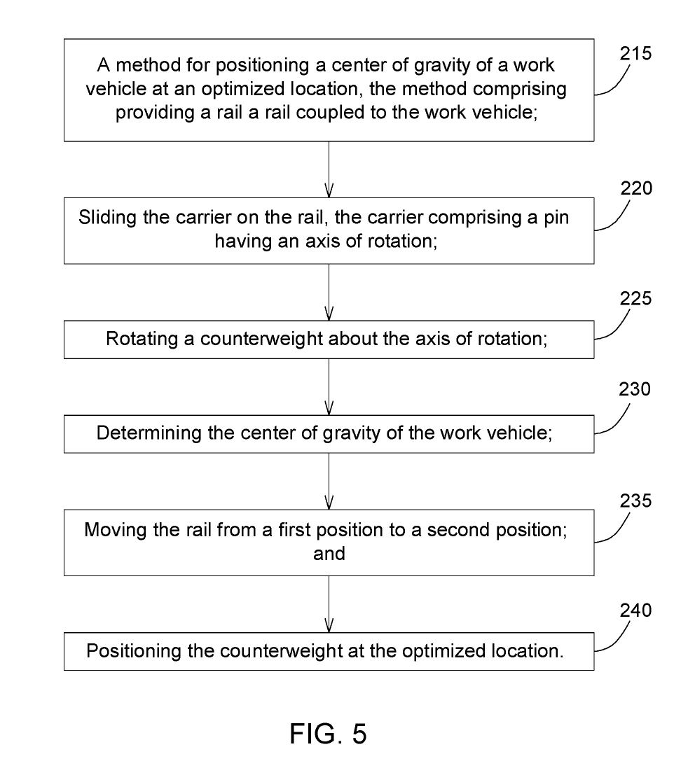

A method for positioning the center of gravity 187 of the work vehicle 10 at the optimized location is illustrated in FIG. 5. In Step 215 the rail 105 is coupled to the work vehicle 10. In Step 220 the carrier 110 is slid on the rail 105. The carrier 110 having the axis of rotation 120. In Step 225 the counterweight 130 is rotated about the axis of rotation 120. In Step 230 the center of gravity 187 of the work vehicle 10 is determined. In Step 235 the rail 105 is moved from the first position 150 to the second position 155. In Step 240 the counterweight 130 is positioned at the optimized location.

Various features are set forth in the following claims.

What is claimed is:

1. A ballast device for a work vehicle, the ballast device comprising:
a rail coupled to the work vehicle;
a carrier slidingly coupled to the rail, the carrier comprising a pin having an axis of rotation;
an actuator coupled to the carrier and configured to move the carrier along the rail;
a counterweight rotatably coupled to the pin;
a rotation device coupled to the counterweight and configured for rotating the counterweight about the axis of rotation;
a sensor coupled to the work vehicle and configured for determining a center of gravity of the work vehicle and for generating a signal indicative of the center of gravity; and
a controller coupled to the work vehicle and configured for receiving the signal and configured for controlling the actuator and the rotation device to position the counterweight at an optimized location.

2. The ballast device of claim 1, further comprising a rail actuator coupled to the rail and configured for moving the rail from a first position to a second position, the controller configured for receiving the signal and configured for controlling the actuator, the rotation device, and the rail actuator to position the counterweight at the optimized location.

3. The ballast device of claim 1, wherein the rail comprises a first rail and a second rail spaced from the first rail.

4. The ballast device of claim 1, wherein the pin comprises an integral motor configured for rotating the counterweight about the axis of rotation.

5. The ballast device of claim 1, wherein the counterweight is configured for rotating 360 degrees about the pin.

6. The ballast device of claim 2, wherein the actuator and the rail actuator are at least one of a hydraulic screw-type actuator and an electric screw-type actuator.

7. The ballast device of claim 1, wherein the sensor is a gyroscope.

8. A work vehicle comprising:
a frame having a recess;
a ballast device coupled to the frame, the ballast device comprising:
a rail coupled to the work vehicle;
a carrier slidingly coupled to the rail, the carrier comprising a pin having an axis of rotation;
an actuator coupled to the carrier and configured to move the carrier along the rail;
a counterweight rotatably coupled to the pin;
a rotation device coupled to the counterweight and configured for rotating the counterweight about the axis of rotation;
a sensor coupled to the work vehicle and configured for determining a center of gravity of the work vehicle and for generating a signal indicative of the center of gravity; and
a controller configured for receiving the signal and configured for controlling the actuator and the rotation device to position the counterweight at an optimized location in the recess.

9. The work vehicle of claim 8, further comprising a rail actuator coupled to the rail and configured for moving the rail from a first position to a second position, the controller configured for receiving the signal and configured for controlling the actuator, the rotation device, and the rail actuator to position the counterweight at the optimized location.

10. The work vehicle of claim 8, wherein the rail comprises a first rail and a second rail spaced from the first rail.

11. The work vehicle of claim 8, wherein the pin comprises an integral motor configured for rotating the counterweight about the axis of rotation.

12. The work vehicle of claim 8, wherein the counterweight is configured for rotating 360 degrees about the pin.

13. The work vehicle of claim 9, wherein the actuator and the rail actuator are at least one of a hydraulic screw-type actuator and an electric screw-type actuator.

14. The work vehicle of claim 8, wherein the sensor is a gyroscope.

15. A method for positioning a center of gravity of a work vehicle at an optimized location, the method comprising:
providing a rail coupled to the work vehicle;
sliding a carrier on the rail, the carrier comprising a pin having an axis of rotation;
rotating a counterweight about the axis of rotation;
determining the center of gravity of the work vehicle; and
positioning the counterweight at the optimized location.

16. The method of claim 16, further comprising moving the rail from a first position to a second position to position the counterweight at the optimized location.

17. The method of claim 16, wherein the rail comprises a first rail and a second rail spaced from the first rail.

18. The method of claim 16, wherein the pin comprises an integral motor configured for rotating the counterweight about the axis of rotation.

19. The method of claim 16, wherein the counterweight is configured for rotating 360 degrees about the pin.
